(19) United States
(12) Patent Application Publication
(10) Pub. No.: US 2008/0106372 A1
(43) Pub. Date: May 8, 2008

(54) AUTHENTICATION METHOD DURING PRODUCT TRANSACTIONS

(76) Inventor: Wei Chang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/609,333

(22) Filed: Dec. 12, 2006

(30) Foreign Application Priority Data
Oct. 19, 2006 (TW) 095138605

(51) Int. Cl. G05B 19/00; G05B 23/00

(52) U.S. Cl. 340/5.8; 340/572.1; 705/67; 235/375; 340/10.1; 340/5.61

(57) ABSTRACT

In a authentication method during product transactions, contact information of a data platform is first written into an RFID tag before integrating the RFID tag with a product. Next, the unique identifier of the RFID tag, the product information and the identification data related to the legitimate owner of the product are stored in the data platform. During a transaction between a buyer and a seller, the buyer receives the contact information of the data platform, the unique identifier of the RFID tag, and the seller information using an electronic device. Based on the contact information of the data platform, the buyer transmits the unique identifier of the RFID tag and the seller information to the data platform. If the seller information matches the identification data related to the legitimate owner of the product, the data platform outputs a confirm signal to the electronic device of the buyer.

### BACKGROUND OF THE INVENTION

1. Field of the Invention

The present invention relates to an authentication method during product transactions, and more particularly, to an authentication method using an RFID tag integrated with a product during product transactions.

2. Description of the Prior Art

Antiques, paintings, stamps or baseball cards have been popular among collectors since these objects possess exceptional meanings or due to possible increases in values in the future. The transactions of these collections can take place in auctions or stores, as well as among fellow collectors. Before performing transactions in auctions or stores, authentication verification is usually performed on high-price products or the works of deceased masters. However, it is too pricy to perform authentication verification on normal products. Also, when the transactions take place among fellow collectors, there is no convenient way for verifying the authentication and the legitimate owner of the product. The buyer can acquire counterfeits or stolen products after spending large amount of money.

### SUMMARY OF THE INVENTION

The present invention provides an authentication method during product transactions comprising writing a contact information of a data platform into an RFID tag; integrating the RFID tag with a product; storing a first identification data related to the RFID tag, a second identification data related to the product, and a third identification data related to a product owner into the data platform; a buyer receiving the contact information of the data platform and the first identification data using a first electronic device; the buyer transmitting the first identification data and a fourth identification data related to a seller to the data platform using the first electronic device based on the contact information of the data platform; and the data platform outputting a transaction signal to the first electronic device.

The present invention further provides an authentication method during product transactions comprising writing a contact information of a data platform into an RFID tag; integrating the RFID tag with a product; storing a first identification data related to the RFID tag, a second identification data related to the product, and a third identification data related to a product owner into the data platform; a buyer receiving the contact information of the data platform and the first identification data using a first electronic device; the buyer transmitting the first identification data to the data platform using the first electronic device based on the contact information of the data platform; and the data platform outputting a reply signal to the first electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an authentication method during product transactions according to a first embodiment of the present invention.

FIG. 2 is a diagram illustrating an authentication method during product transactions according to a second embodiment of the present invention.

### DETAILED DESCRIPTION

In the past, bar codes are used for storing product information so that product circulation can be monitored and controller. However, data transmission using bar codes is inconvenient and inefficient since bar codes only provide limited data storage capacity and require line-of-sight scanning. Therefore, radio frequency identification (RFID) tags have been developed for such applications. An RFID tag operative based on a built-in RF technology includes a chip having an unique identifier (UID) and a built-in antenna. The chip of the RFID tag can store various information, such as the UID, the product name, the publish date of the product or the product descriptions. The RFID tags are advantageous in large data storage/access capacity and wireless data transmission.

In the present invention, an RFID tag integrated with a product is used as the unique identification of the product during transactions. First, the creator, owner or publisher of a collection (hereafter referred to as the original owner) entrusts a collection or a creation (hereafter referred to as the product) to a associated organization or a group (hereafter referred to as the anti-counterfeit organization), which then integrates a read-only RFID tag with the product. The RFID tag can be integrated with the product in many ways, such as by embedding the RFID tag into the product similar to manufacturing a credit card with an IC chip or by attaching the RFID tag to the product using appropriate adhesives. An attempt to remove the RFID tag by force will result in apparent marks on the RFID tag, or damage the antenna of the RFID tag. Therefore, when the RFID tag shows abnormal appearance or data stored in the RFID tag cannot be accessed, it can be easily determined that the RFID tag is no longer intact. The RFID tag can include information such as the UID, the product name, the product creator/publisher, the publish date, the product descriptions, and the contact information of the anti-counterfeit organization (such as the website or the IP address of a data platform).

After integrating the RFID tag with the product, the anti-counterfeit organization registers product-related information at a data platform. The data platform can be a system established by the anti-counterfeit organization or by other data organizations. The registered data can include the UID of the RFID tag, the product information (such as the name, the creator/publisher, the publish date of the product, or the product descriptions), and the identification data of the product owner (such as the name, the mobile phone number or the confirmation code of the product owner). When the data related to the product is stored in the data platform for the first time, the legitimate owner of the product is the original owner. When the product is sold to a buyer for the first time, data related to the buyer (such as the name, the mobile phone number or the confirmation code of the buyer) can be registered on the data platform, and the legitimate owner of the product is updated to the buyer. Afterward, the legitimate owner of the product can update the mobile phone number of perform transactions using its confirmation code. After each transaction, the data platform can update the data related to the legitimate owner of the product based on the data related to the most recent buyer. The method for updating data registered on the data platform will be described in more detail in the following paragraphs.

During the transaction of the product between a buyer and a seller, the buyer can receive the data stored in the RFID tag of the product and the seller information using an adequate electronic device. Next, the data related to the current legitimate owner of the product can be acquired by wirelessly connecting to the data platform. The buyer can thus determine whether the seller information corresponds to the data related to the legitimate owner of the product registered on the data platform. If the seller is confirmed to be the current legitimate owner of the product, the transaction can proceed and the ownership of the product can be updated on the data platform. The method for updating the ownership of the product will be described in more detail in the following paragraphs. If the seller information does not correspond to the data related to the legitimate owner of the product registered on the data platform, the buyer can be informed that the product may be a counterfeit or a stolen object. Therefore, the present authentication method can prevent easy circulations of counterfeits or stolen objects in the market.

In the present invention, the electronic devices used by the buyer and the seller during product transactions can include devices capable of accessing RFID tags, such as mobile phones, personal digital assistants (PDA), notebook computers or personal computers. In addition to the ability of accessing RFID tags, the electronic devices of the buyer and the seller can transmit data based on communication protocols such as bluetooth or near field communication (NFC) standards. Also, the electronic devices of the buyer and the seller can be connected to the data platform via a wireless network, such as a wireless network based on general packet radio service (GPRS), wireless fidelity (Wi-Fi) or third generation (3G) standards.

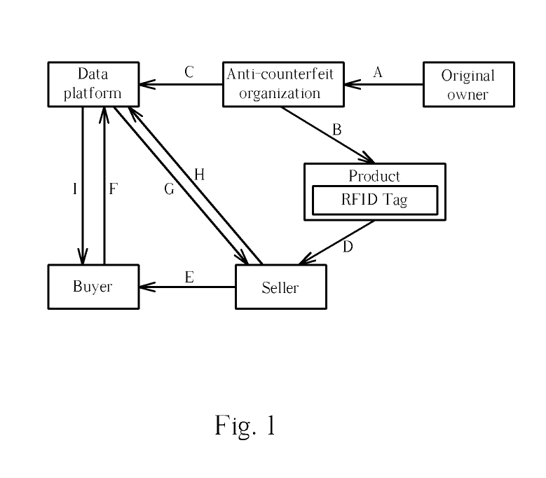

Reference is made to FIG. 1 for a diagram illustrating an authentication method during product transactions according to a first embodiment of the present invention. The arrows in FIG. 1 illustrate the data transmission between the original owner, the product, the anti-counterfeit organization, the data platform, the buyer and the seller. In the first embodiment of the present invention, the buyer and the seller access and transmit data using respective mobile phones. First, the original owner entrusts the product to the anti-counterfeit organization, and provides the anti-counterfeit organization with personal information and product information including the product name, the publish date of the product or the product descriptions (arrow A). Next, the anti-counterfeit organization writes the contact information of the data platform into an RFID tag and integrate the RFID with the product (arrow B). At the same time, the anti-counterfeit organization registers the personal data of the original owner, the product information and the UID of the RFID tag on the data platform (arrow C). Therefore, when a user accesses the data platform based on the UID of the RFID tag, the registered data shows that the original owner is the current legitimate owner of the product.

In the first transaction, the product can be traded via the anti-counterfeit organization. After the first transaction, the anti-counterfeit organization registers on the data platform a transaction record including the buyer information (such as the name, the mobile phone number and the confirmation code of the buyer), the transaction time or the transaction price, and updates the registered data related to the legitimate owner of the product based on the buyer information (arrow C). Afterward, when a buyer intends to buy the product from a seller, the seller can be the legitimate or an illegal owner of the product, and the product can be genuine or faked. The buyer can verify the transaction using the authentication method according to the first embodiment of the present invention, which is explained as follows.

First, the seller can put his mobile phone in the vicinity of the RFID tag integrated with the product while pressing a specific button of his mobile phone, and then releases the button in order to begin accessing the data stored in the RFID tag. After accessing the data successfully, the mobile phone of the seller generates a “beep” sound once for informing the seller that his mobile phone has completed receiving the data stored in the RFID tag (arrow D). Next, the seller can put his mobile phone in the vicinity of the mobile phone of the buyer while pressing a specific button, and then releases the button in order to begin transmitting the seller information stored in the mobile phone of the seller. After completing data transmission, the mobile phone of the seller generates a “beep” sound twice for informing the buyer that his mobile phone has received the data stored in the mobile phone of the seller (arrow E). Under these circumstances, the buyer can receive information including the UID of the RFID tag integrated with the product, the contact information of the data platform (such as the website or the IP address of the data platform), and the seller information (such as the name, the mobile phone number or the confirmation code of the seller).

Next, the application system in the mobile phone of the buyer transmits the UID of the RFID tag and the seller information to the data platform (arrow F) when the buyer presses a specific button of his mobile phone. Based on the UID of the RFID tag, the data platform searches in the database for the corresponding data related to the legitimate owner of the product, and then determines whether the seller information sent by the buyer matches the data related to the legitimate owner of the product. If the data related to the current legitimate owner of the product matches the seller information, the data platform sends a notification message to the seller (arrow G) for confirming the transaction. After receiving the notification message from the data platform, the seller can reply a confirmation message (arrow H) as required by the data platform, such as the preset confirmation code of the seller. After receiving the confirmation message from the seller, the data platform adds a corresponding transaction record (such as the names of the buyer and seller or the transaction time) to the database, and updates the legitimate owner of the product from the seller to the buyer. Last, the data platform sends a message to the buyer (arrow I) for notifying a successful transaction and demands a new confirmation code from the buyer (arrow F) as the confirmation message during future transactions or modifications of the mobile phone number. If the data related to the current legitimate owner of the product does not match the seller information, the data platform sends a warning message to the buyer (arrow I) for informing the buyer that the product can be a counterfeit or a stolen object.

In the first embodiment of the present invention, the product can be traded via the anti-counterfeit organization in the first transaction. Or, the first transaction of the product can be conducted directly between the original owner of the product and a buyer. If the first transaction of the product is conducted directly between the original owner of the product and the buyer, the original owner and the seller in FIG. 1 are the same person. After the anti-counterfeit organization writes the contact information of the data platform into the RFID tag, integrates the RFID tag with the product (arrow B), the data of the original owner, the product information and the UID of the RFID tag are registered on the data platform (arrow C). The buyer and the seller can perform transaction verification based on the aforementioned steps.

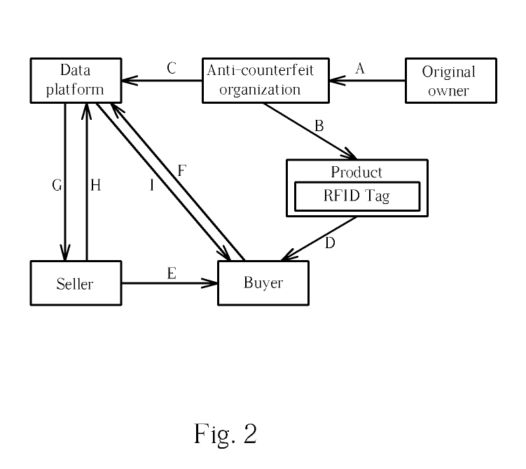

Reference is made to FIG. 2 for a diagram illustrating an authentication method during product transactions according to a second embodiment of the present invention. The arrows in FIG. 2 also illustrate the data transmission between the original owner, the product, the anti-counterfeit organization, the data platform, the buyer and the seller. In the second embodiment of the present invention, the buyer and the seller access and transmit data using respective mobile phones. First, the original owner entrusts the product to the anti-counterfeit organization, and provides the anti-counterfeit organization with personal information and product information including the product name, the publish date of the product or the product descriptions (arrow A). Next, the anti-counterfeit organization writes the contact information of the data platform into an RFID tag and integrate the RFID with the product (arrow B). At the same time, the anti-counterfeit organization registers the personal data of the original owner, the product information and the UID of the RFID tag on the data platform (arrow C). Therefore, when a user accesses the data platform based on the UID of the RFID tag, the registered data shows that the original owner is the current legitimate owner of the product.

In the first transaction, the product can be traded via the anti-counterfeit organization. After the first transaction, the anti-counterfeit organization registers on the data platform a transaction record including the buyer information (such as the name, the mobile phone number and the confirmation code of the buyer) or the transaction time, and updates the registered data related to the legitimate owner of the product based on the buyer information (arrow C). Afterward, when a buyer intends to buy the product from a seller, the seller can be the legitimate or an illegal owner of the product, and the product can be genuine or faked. The buyer can verify the transaction using the authentication method according to the second embodiment of the present invention, which is explained as follows.

First, the buyer can put his mobile phone in the vicinity of the RFID tag integrated with the product while pressing a specific button of his mobile phone, and then releases the button in order to begin accessing the data stored in the RFID tag. After accessing the data successfully, the mobile phone of the buyer generates a “beep” sound once for informing the buyer that his mobile phone has completed receiving the data stored in the RFID tag (arrow D). Next, the buyer can put his mobile phone in the vicinity of the mobile phone of the seller while pressing a specific button, and then releases the button in order to begin accessing the seller information stored in the mobile phone of the seller. After completing data access, the mobile phone of the buyer generates a “beep” sound twice for informing the buyer that his mobile phone has received the data stored in the mobile phone of the seller (arrow E). Under these circumstances, the buyer can receive information including the UID of the RFID tag integrated with the product, the contact information of the data platform (such as the website or the IP address of the data platform), and the seller information (such as the name, the mobile phone number or the confirmation code of the seller).

Next, the application system in the mobile phone of the buyer transmits the UID of the RFID tag and the seller information to the data platform (arrow F) when the buyer presses a specific button of his mobile phone. Based on the UID of the RFID tag, the data platform searches in the database for the corresponding data related to the legitimate owner of the product, and then determines whether the seller information sent by the buyer matches the data related to the legitimate owner of the product. If the data related to the current legitimate owner of the product matches the seller information, the data platform sends a notification message to the seller (arrow G) for confirming the transaction. After receiving the notification message from the data platform, the seller can reply a confirmation message (arrow H) as required by the data platform, such as the preset confirmation code of the seller. After receiving the confirmation message from the seller, the data platform adds a corresponding transaction record (such as the names of the buyer and seller or the transaction time) to the database, and updates the legitimate owner of the product from the seller to the buyer. Last, the data platform sends a message to the buyer (arrow I) for notifying a successful transaction and demands a new confirmation code from the buyer (arrow F) as the confirmation message during future transactions or modifications of the mobile phone number. If the data related to the current legitimate owner of the product does not match the seller information, the data platform sends a warning message to the buyer (arrow I) for informing the buyer that the product can be a counterfeit or a stolen object.

In the second embodiment of the present invention, the product can be traded via the anti-counterfeit organization in the first transaction. Or, the first transaction of the product can be conducted directly between the original owner of the product and a buyer. If the first transaction of the product is conducted directly between the original owner of the product and the buyer, the original owner and the seller in FIG. 2 are the same person. After the anti-counterfeit organization writes the contact information of the data platform into the RFID tag, integrates the RFID tag with the product (arrow B), the data of the original owner, the product information and the UID of the RFID tag are registered on the data platform (arrow C). The buyer and the seller can perform transaction verification based on the aforementioned steps.

In the present invention, the buyer can confirm the authenticity and legality of the product based on aforementioned methods, and the rights of the original owner can be guaranteed. Product authentication can easily be conducted between a seller and a buyer using portable electronic devices, thereby preventing easy circulations of counterfeits or stolen objects in the market.

In a third embodiment of the present invention, instead of using short-range data transmission between the mobile phones of a seller and as buyer, the present authentication method is conducted by the buyer on a long-range basis, such as via telephones, e-Mails or auction websites. After receiving a product integrated with an RFID tag mailed by the seller, the buyer can put his mobile phone in the vicinity of the RFID tag integrated with the product while pressing a specific button of his mobile phone, and then releases the button in order to begin accessing the data stored in the RFID tag. After accessing the data successfully, the mobile phone of the buyer generates a “beep” sound once for informing the buyer that his mobile phone has received the data stored in the RFID tag, such as the contact information of the data platform and the UID of the RFID tag. Next, the buyer can receive the product information by connecting to the data platform and inputting the UID using his mobile phone. After confirming that the product is genuine and the seller is the legitimate owner of the product, the buyer can pay for the product. The seller then sends his confirmation code to the buyer after receiving the payment for the product. After the buyer connects to the data platform for updating data related to the legitimate owner of the product using the confirmation code of the seller, the data platform sends a new confirmation code to the buyer for future transactions. The data platform can also register a corresponding transaction record for future references. If the buyer does not pay for the product, the seller can refuse to provide his confirmation code. Therefore, the buyer cannot become the legitimate owner of the product for future transaction.

In a fourth embodiment of the present invention, instead of using short-range data transmission between the mobile phones of a seller and as buyer, the present authentication method is conducted by the seller on a long-range basis, such as via telephones, e-Mails or auction websites. After receiving a product integrated with an RFID tag mailed by the seller, the buyer can put his mobile phone in the vicinity of the RFID tag integrated with the product while pressing a specific button of his mobile phone, and then releases the button in order to begin accessing the data stored in the RFID tag. After accessing the data successfully, the mobile phone of the buyer generates a “beep” sound once for informing the buyer that his mobile phone has received the data stored in the RFID tag, such as the contact information of the data platform and the UID of the RFID tag. Next, the buyer can receive the product information by connecting to the data platform and inputting the UID using his mobile phone. After confirming that the product is genuine and the seller is the legitimate owner of the product, the buyer can pay for the product and demands the data platform to update data related to the legitimate owner of the product. The data platform then sends a notification message to the seller in order to confirm the transaction. After receiving the payment for the product from the buyer, the seller can reply a confirmation message as required by the notification message, such as a present code of the seller. After receiving the confirmation message from the seller, the data platform updates the legitimate owner of the product to the buyer and sends a new confirmation code to the buyer for future transactions. If the buyer does not pay for the product, the seller can refuse to provide his confirmation code. Therefore, the buyer cannot become the legitimate owner of the product for future transaction. If the buyer already pays for the product, the buyer can ask the seller to update the legitimate owner of the product by providing a corresponding payment receipt.

In order to prevent oblivion and peep, the confirmation codes used in the present invention can be encrypted using programs of the mobile phones, stored in the memory devices of the mobile phones, and decrypted during data transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A authentication method during product transactions comprising:
writing a contact information of a data platform into a radio frequency identification (RFID) tag;
integrating the RFID tag with a product;
storing a first identification data related to the RFID tag, a second identification data related to the product, and a third identification data related to a product owner into the data platform;
a buyer receiving the contact information of the data platform and the first identification data using a first electronic device;
the buyer transmitting the first identification data and a fourth identification data related to a seller to the data platform using the first electronic device based on the contact information of the data platform; and
the data platform outputting a transaction signal to the first electronic device.

2. The method of claim 1 wherein the first electronic device includes a means for accessing the RFID tag.

3. The method of claim 1 further comprising:
a buyer storing the fourth identification data in a second electronic device.

4. The method of claim 3 wherein the second electronic device includes a means for accessing the RFID tag.

5. The method of claim 1 wherein the buyer accesses the RFID tag for receiving the contact information of the data platform and the first identification data using the first electronic device.

6. The method of claim 5 further comprising:
the seller transmitting the fourth identification data to the first electronic device using a second electronic device.

7. The method of claim 6 wherein the second electronic device transmits the fourth identification data to the first electronic device based on bluetooth or near field communication (NFC) standards.

8. The method of claim 1 further comprising:
the seller accessing the first identification data and the contact information of the data platform using a second electronic device; and
the seller transmitting the first identification data, the fourth identification data, and the contact information of the data platform to the first electronic device.

9. The method of claim 8 wherein the second electronic device transmits the first identification data, the fourth identification data, and the contact information of the data platform to the first electronic device based on bluetooth or NFC standards.

10. The method of claim 1 wherein the third identification data includes a name and a contact information of the product owner.

11. The method of claim 1 further comprising:
the data platform determining whether the fourth identification data corresponds to the third identification data.

12. The method of claim 11 further comprising:
the data platform demanding a replay signal from the seller when the fourth identification data corresponds to the third identification data.

13. The method of claim 12 further comprising:
the seller transmitting the replay signal to the data platform using the second electronic device.

14. The method of claim 13 wherein the replay signal includes a preset code of the product owner.

15. The method of claim 14 further comprising:
the data platform outputting the transaction signal to the first electronic device when the reply signal corresponds to the preset code of the product owner.

16. The method of claim 11 further comprising:
the data platform demanding a fifth identification data related to the buyer from the buyer when the fourth identification data corresponds to the third identification data.

17. The method of claim 16 wherein the fifth identification data includes a name, a contact information, and a preset code of the buyer.

18. The method of claim 16 further comprising:
the data platform updating data related to the product owner based on the fifth identification data.

19. The method of claim 16 further comprising:
the data platform adding a transaction data based on the fourth and fifth identification data.

20. The method of claim 14 further comprising:
the data platform outputting the transaction signal as a warning signal to the first electronic device when the reply signal does not correspond to the preset code of the product owner.

21. The method of claim 1 wherein the first identification data includes a unique identifier (UID) of the RFID tag.

22. The method of claim 1 wherein the contact information of the data platform is an IP address of the data platform.

23. The method of claim 1 wherein the second identification data includes a name or a description of the product.

24. The method of claim 1 further comprising:
the buyer connecting to the data platform using the first electronic device and via a wireless network based on the contact information of the data platform.

25. The method of claim 24 wherein the buyer connects to the data platform via the wireless network based on general packet radio service (GPRS), wireless fidelity (Wi-Fi), or third generation (3G) standards.

26. A authentication method during product transactions comprising:
writing a contact information of a data platform into an RFID tag;
integrating the RFID tag with a product;
storing a first identification data related to the RFID tag, a second identification data related to the product, and a third identification data related to a product owner into the data platform;
a buyer receiving the contact information of the data platform and the first identification data using a first electronic device;
the buyer transmitting the first identification data to the data platform using the first electronic device based on the contact information of the data platform; and
the data platform outputting a reply signal to the first electronic device.

27. The method of claim 26 wherein the third identification data includes data of the product owner and a preset code of the product owner.

28. The method of claim 27 wherein the reply signal includes the second identification data and the data of the product owner.

29. The method of claim 27 further comprising:
connecting to the data platform;
inputting the preset code of the product owner to the data platform;
updating the product owner to the buyer; and
updating the preset code of the product owner.

30. The method of claim 29 wherein inputting the preset code to the data platform is the product owner inputting the preset code to the data platform.

31. The method of claim 27 wherein after receiving the preset code of the product owner, the buyer connects to the data platform for inputting the preset code of the product owner.

32. The method of claim 31 wherein the buyer connects to the data platform using the first electronic device.

33. The method of claim 26 wherein the first electronic device includes a means for accessing the RFID tag.

34. The method of claim 30 further wherein the preset code is stored in a second electronic device of the owner.
